(19) United States
(12) Patent Application Publication
(10) Pub. No.: US 2022/0036206 A1
(43) Pub. Date: Feb. 3, 2022

(54) CONTAINERIZED DISTRIBUTED RULES ENGINE

(71) Applicant: Red Hat, Inc., Raleigh, NC (US)

(72) Inventors: Edoardo Vacchi, Milan (IT); Daniele Zonca, Milan (IT)

(21) Appl. No.: 17/005,223

(22) Filed: Aug. 27, 2020

Related U.S. Application Data
(60) Provisional application No. 63/058,260, filed on Jul. 29, 2020.

(51) Int. Cl. G06N 5/02; G06F 9/54

(52) U.S. Cl. CPC G06N 5/025; G06F 9/544

(57) ABSTRACT

A method includes generating a rule unit as a containerized microservice on a cloud platform. The method further includes deploying, by a processing device, the containerized microservice on a container platform. The method further includes enabling message passing between the containerized microservice and additional containerized microservices over a shared channel.

### CROSS REFERENCE TO RELATED APPLICATIONS

This application claims the benefit of U.S. Provisional Application Ser. No. 63/058,260, entitled “Containerized Distributed Rules Engine,” filed Jul. 29, 2020, the disclosure of which is incorporated herein by reference in its entirety.

### TECHNICAL FIELD

Aspects of the present disclosure relate to distributed rules engines on cloud platforms and more specifically, to a containerized distributed rules engine.

### BACKGROUND

A rules engine is a software system that executes rules with respect to the state of its working memory. Rules engines are utilized in a variety of contexts to apply the given rules to data to produce outcomes. Rules engines may be included as one component of larger systems, such as software management systems.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1A is a block diagram that illustrates a first example system, in accordance with some embodiments of the present disclosure.

FIG. 1B is a block diagram that illustrates a second example system, in accordance with some embodiments of the present disclosure.

FIG. 1C is a block diagram that illustrates a third example system, in accordance with some embodiments of the present disclosure.

FIG. 2 is a block diagram that illustrates an example rules engine, in accordance with some embodiments of the present disclosure.

FIG. 3 is a block diagram that illustrates an example rule unit, in accordance with some embodiments of the present disclosure.

FIG. 4 is a block diagram that illustrates an example scheduler, in accordance with some embodiments of the present disclosure.

FIG. 5 is a block diagram that illustrates example shared message channels, in accordance with some embodiments of the present disclosure.

FIG. 6 is a block diagram that illustrates an updated rules engine, in accordance with some embodiments of the present disclosure.

FIG. 7 is a block diagram that illustrates a container platform, in accordance with some embodiments of the present disclosure.

FIG. 8 is a block diagram that illustrates an updated scheduling and messaging platform, in accordance with some embodiments of the present disclosure.

FIG. 9A is a flow diagram of a first method of the containerized distributed rules engine, in accordance with some embodiments of the present disclosure.

FIG. 9B is a flow diagram of a second method of the containerized distributed rules engine, in accordance with some embodiments of the present disclosure.

FIG. 10 is a block diagram of an example computing device that may perform one or more of the operations described herein, in accordance with some embodiments of the present disclosure.

### DETAILED DESCRIPTION

In one embodiment, a mechanism to realize a distributed rule system on a cloud platform through containerization of a partition of the rule base and communication via message passing on shared channels is described herein. In one embodiment, rules engines may include software systems that execute rules with respect to the state their respective working memories. Rules engines may be utilized in a variety of contexts to apply the given rules to data to produce outcomes. Rules engines may be included as one component of larger systems, such as software management systems, for example.

In one embodiment, rules of rules engines may be stored in a production memory and the facts that an inference engine matches against are kept in a working memory. Facts may be asserted into the working memory where they may then be modified or retracted. Problematically, a system with a large number of rules and facts may result in many rules being true for the same fact assertion. These rules may be said to be in conflict. In one embodiment, a scheduler may manage the execution order of these conflicting rules using a conflict resolution strategy. A variety of implementations of rules engines may be utilized. For example, in one embodiment, forward chaining and backward chaining systems may be used. In another embodiment, a hybrid of the two systems may be used. led Hybrid Chaining Systems.

In one embodiment, forward chaining is “data-driven” and thus reactionary, with facts being asserted into working memory, which problematically may result in one or more rules being concurrently true and scheduled for execution by the engine. In short, the engine starts with a fact, it propagates, and ends with a conclusion.

In another embodiment, backward chaining may be “goal-driven,” meaning that the engine starts with a conclusion which the engine tries to satisfy. If it cannot, it then searches for conclusions that it can satisfy. In one embodiment, these are known as subgoals that will help satisfy some unknown part of the current goal. It continues this process until either the initial conclusion is proven or there are no more subgoals.

A variety of problems exist with traditional rules engines. For example, rules engines can become so large that storage can resource-intensive and inefficient. Given that rules engines may be stored in the cloud (e.g., in a cloud-based system), increasingly large rules engines can become difficult to manage as storage, throughput, and overall resource management may be more of an issue. Another problem with traditional rules engines is that cloud-based engines, wherein rule engines may be stored and from which they may be executed, may be required to maintain a level of compatibility with other cloud and non-cloud based services. Maintaining such necessary compatibility can be a challenge without taking specific measures to ensure such compatibility. Until now, measures that would enable such efficient and reliable compatibility did not exist.

Advantageously, the embodiments of the present disclosure overcome the above, another other, challenges, by providing for a distributed rule system on a cloud platform through containerization of a partition of the rule base and communication via message passing on shared channels. An example of such a solution can be found in Red Hat® Decision Manager, for example. In one embodiment, the distributed and containerized nature of the system described herein ensures that the rules engine is resource efficient and compatible with other suitable software systems.

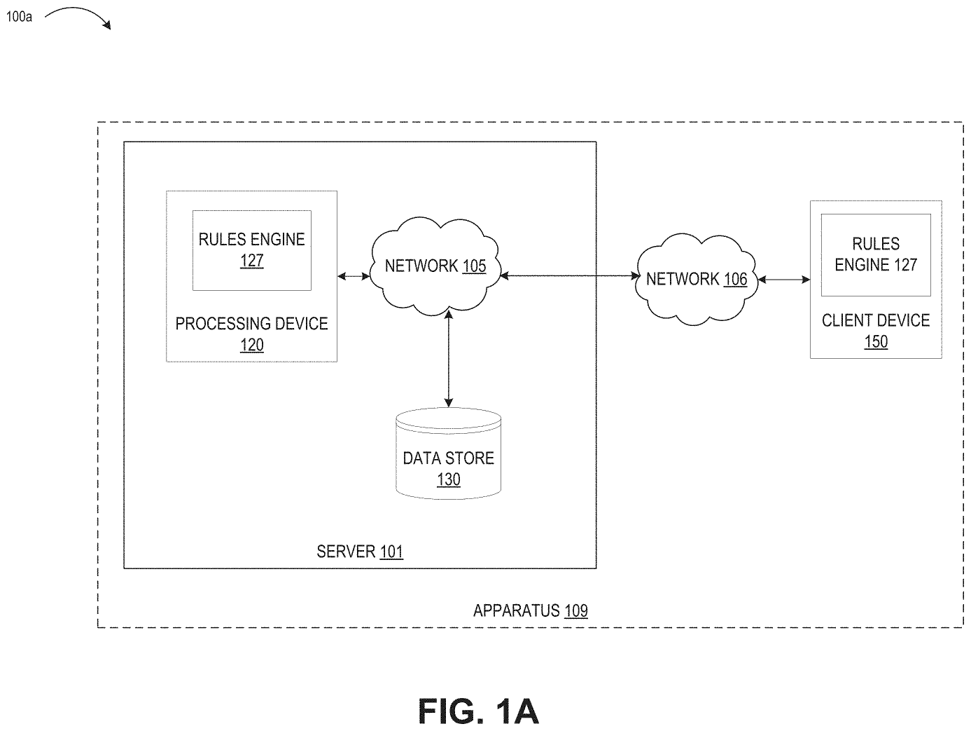

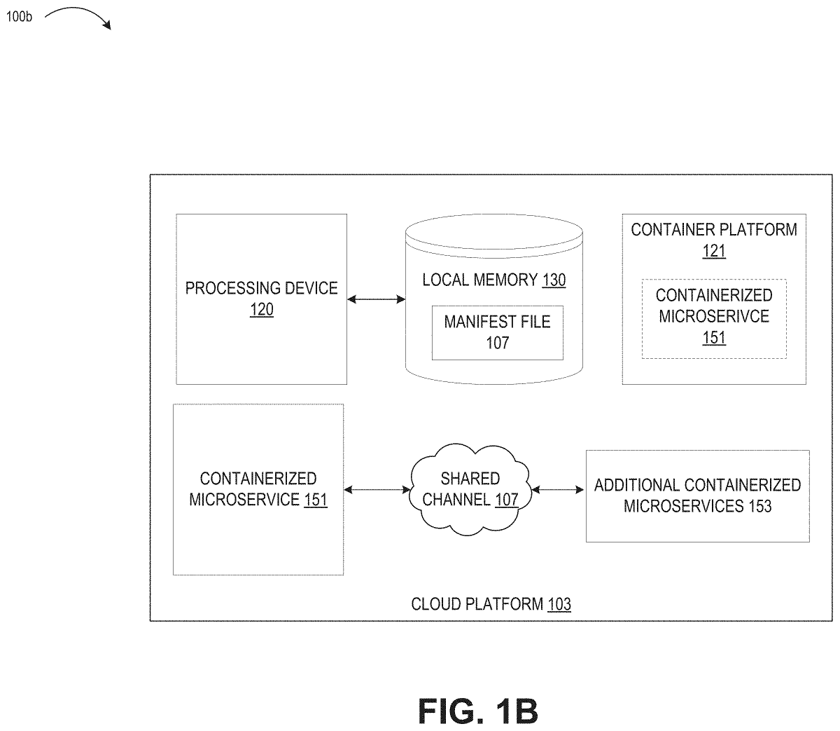

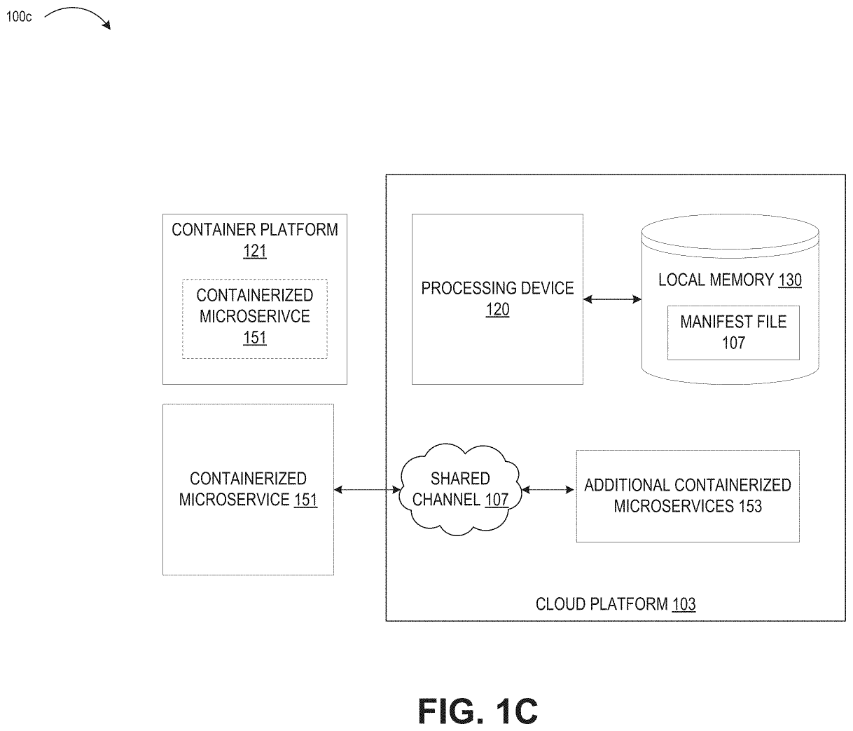

FIG. 1A is a block diagram that illustrates a first example system 100a, in accordance with some embodiments of the present disclosure. As discussed herein, rules engine 127 may include logic that enables the operations and systems described herein, when executed. In one embodiment, system 100a may be described as an apparatus 109, including means for performing the operations described herein (e.g., server 101, network 106, client device 150, etc.). In one embodiment, rules engine 127 resides in whole or in part on a server (e.g., server 101) of system 100a. In another embodiment, rules engine 127 resides in whole or in part on a client device (e.g., client device 150) of system 100a. In yet another embodiment, rules engine 127 resides in whole or in part on any combination of the two, or in a different system entirely.

Server 101 may include various components, which may allow rules engine 127 to run on a server device or client device. Each component may perform different functions, operations, actions, processes, methods, etc., for the embodiments described herein and/or may provide different services, functionalities, and/or resources for the embodiments described herein.

As illustrated in FIG. 1A, server 101 includes a rules engine 127, a computing processing device 120, a data store 130, and a network 105. The rules engine 127, the processing device 120, and the data store 130 may be coupled to each other (e.g., may be operatively coupled, communicatively coupled, may communicate data/messages with each other) via network 105. Network 105 may be a public network (e.g., the internet), a private network (e.g., a local area network (LAN) or wide area network (WAN)), or a combination thereof. In one embodiment, network 105 may include a wired or a wireless infrastructure, which may be provided by one or more wireless communications systems, such as a Wi-Fi hotspot connected with the network 105 and/or a wireless carrier system that can be implemented using various data processing equipment, communication towers (e.g. cell towers), etc.

The network 105 may carry communications (e.g., data, message, packets, frames, etc.) between the various components of server 101. The data store 130 may be a persistent storage that is capable of storing data. A persistent storage may be a local storage unit or a remote storage unit. Persistent storage may be a magnetic storage unit, optical storage unit, solid state storage unit, electronic storage units (main memory), or similar storage unit. Persistent storage may also be a monolithic/single device or a distributed set of devices.

Each component may include hardware such as processing devices (e.g., processors, central processing units (CPUs)), memory (e.g., random access memory (RAM)), storage devices (e.g., hard-disk drive (HDD), solid-state drive (SSD), etc.), and other hardware devices (e.g., sound card, video card, etc.). The server 101 may comprise any suitable type of computing device or machine that has a programmable processor including, for example, server computers, desktop computers, laptop computers, tablet computers, smartphones, set-top boxes, etc. In some examples, the server 101 may comprise a single machine or may include multiple interconnected machines (e.g., multiple servers configured in a cluster). The server 101 may be implemented by a common entity/organization or may be implemented by different entities/organizations. For example, a server 101 may be operated by a first company/corporation and a second server (not pictured) may be operated by a second company/corporation. Each server may execute or include an operating system (OS), as discussed in more detail below. The OS of a server may manage the execution of other components (e.g., software, applications, etc.) and/or may manage access to the hardware (e.g., processors, memory, storage devices etc.) of the computing device.

In one embodiment, server 101 is operably connected to client device 150 via a network 106. Network 106 may be a public network (e.g., the internet), a private network (e.g., a local area network (LAN) or wide area network (WAN)), or a combination thereof. In one embodiment, network 106 may include a wired or a wireless infrastructure, which may be provided by one or more wireless communications systems, such as a Wi-Fi hotspot connected with the network 106 and/or a wireless carrier system that can be implemented using various data processing equipment, communication towers (e.g. cell towers), etc. The network 106 may carry communications (e.g., data, message, packets, frames, etc.) between the various components of system 101. Client device 150 may include rules engine 127, in addition to, or alternatively from, server 101. Further implementation details of the operations performed by system 101 are described with respect to FIGS. 1B-6.

FIG. 1B is a block diagram that illustrates a second example system 100b, in accordance with some embodiments of the present disclosure. System 100b includes a cloud platform 103, which may include one or more components. For example, cloud platform 103 may include processing device 120, local memory 130 (e.g., to store a manifest file 107), container platform 121 (e.g., to store and manage one or more containerized microservices), and a variety of containerized microservices (e.g., 151, 153, etc.) that communicate over one or more shared channels (e.g., 107).

In one embodiment, cloud platform 103 may perform any number of suitable rules engine operations, as described herein. For example, in one embodiment, processing device 120 may generate a rule unit as a containerized microservice 151 on the cloud platform 103, deploy the containerized microservice 151 on the container platform 121, and enable message passing between the containerized microservice 151 and additional containerized microservices 153 (all, or some of which, may be located within or outside of container platform 121) over a shared channel 107.

In one embodiment, to generate the rule unit as the containerized microservice 151 the processing device 120 may first identify the rule unit in the manifest file 107 (block 908), and then generate a rule unit microservice including one or more rules of the manifest file 910. Processing device 120 may then package the rule unit microservice into a rule unit container as the containerized microservice 151, or into one or more distinct containerized microservices (e.g., 153) (block 912). In on embodiment, processing device 120 may generate the one or more rules of the manifest file in an executable format. For example, the executable format may be generated in Java® or a native executable. In one embodiment, the executable format may provide read and write access to a data source corresponding to the rule via an application programming interface (API). In one embodiment, the API may the API is a representational state transfer (REST) API. In another embodiment, a message bus may be employed.

To deploy the containerized microservice 151 on the container platform 121 the processing device 120 may associate, from the manifest file 107, a data source of the containerized microservice 151 to a corresponding backing channel and initialize a container platform scheduler to schedule the containerized microservice for execution.

Execution of the microservice may be performed by the scheduler in a variety of contexts. For example, in one embodiment, processing device 120 may identify a fact in a queue associated with the containerized microservice, store the fact in the local memory associated with the containerized microservice (e.g., in local memory 130), and execute the containerized microservice 151. In one embodiment, processing device 120 may further update the fact in the local memory 130 in view of the executing and propagate the updated fact to the one or more additional containerized microservices 153 via the shared channel 107.

FIG. 1C is a block diagram that illustrates a third example system 100c, in accordance with some embodiments of the present disclosure. System 100c includes a cloud platform 103, which may include one or more components. For example, cloud platform 103 may include processing device 120, local memory 130 (e.g., to store a manifest file 107), and a variety of containerized microservices (e.g., 151, 153, etc.) that communicate over one or more shared channels (e.g., 107). In one embodiment, container platform 121 (e.g., to store and manage one or more containerized microservices) may reside outside of cloud platform 103, as shown. In another embodiment, one or more containerized microservices (e.g., 151) may reside outside of cloud platform 103.

As described above, in one embodiment, cloud platform 103 may perform any number of suitable rules engine operations, as described herein. For example, in one embodiment, processing device 120 may generate a rule unit as a containerized microservice 151 on the cloud platform 103, deploy the containerized microservice 151 on the container platform 121, and enable message passing between the containerized microservice 151 and additional containerized microservices 153 (all, or some of which, may be located within or outside of container platform 121 and/or cloud platform 103) over a shared channel 107.

In one embodiment, to generate the rule unit as the containerized microservice 151 the processing device 120 may first identify the rule unit in the manifest file 107, and then generate a rule unit microservice including one or more rules of the manifest file. Processing device 120 may then package the rule unit microservice into a rule unit container as the containerized microservice 151, or into one or more distinct containerized microservices (e.g., 153). In on embodiment, processing device 120 may generate the one or more rules of the manifest file in an executable format. For example, the executable format may be generated in Java® or a native executable. In one embodiment, the executable format may provide read and write access to a data source corresponding to the rule via an application programming interface (API). In one embodiment, the API may the API is a representational state transfer (REST) API. In another embodiment, a message bus may be employed.

To deploy the containerized microservice 151 on the container platform 121 the processing device 120 may associate, from the manifest file 107, a data source of the containerized microservice 151 to a corresponding backing channel and initialize a container platform scheduler to schedule the containerized microservice for execution.

Execution of the microservice may be performed by the scheduler in a variety of contexts. For example, in one embodiment, processing device 120 may identify a fact in a queue associated with the containerized microservice, store the fact in the local memory associated with the containerized microservice (e.g., in local memory 130), and execute the containerized microservice 151. In one embodiment, processing device 120 may further update the fact in the local memory 130 in view of the executing and propagate the updated fact to the one or more additional containerized microservices 153 via the shared channel 107.

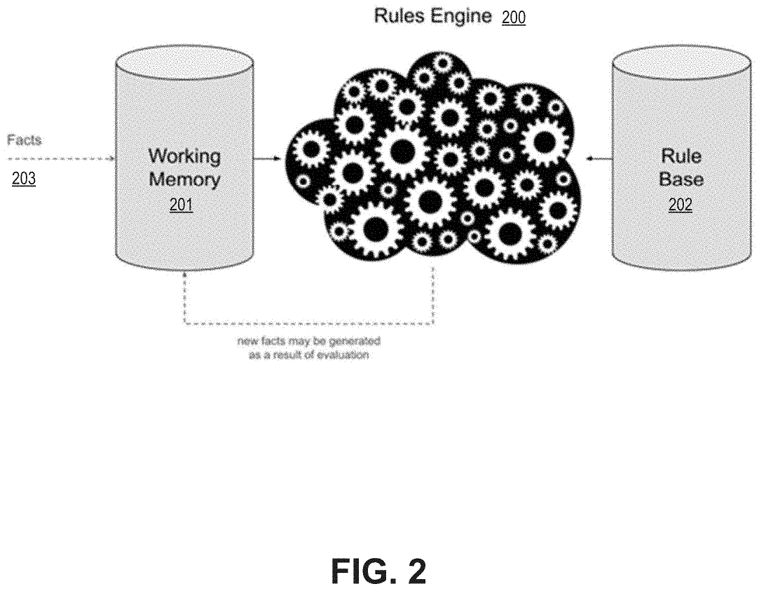

FIG. 2 is a block diagram that illustrates an example rules engine 200, in accordance with some embodiments of the present disclosure. In one embodiment, rules engine 200 is a software system that executes rules with respect to the state of its working memory 201. In one embodiment, the working memory 201 contains the state of the system onto which rules are evaluated. Each piece of data in the working memory is may be referred to as a fact 203. In one embodiment, facts 203 may be inserted into and stored by the working memory 20.

In one embodiment, a rule is a small piece of code of the form when <condition> then <consequence>. The <condition> may be a constraint over part of the working memory. The <consequence> may be a snippet of executable code, written in some programming language. In one embodiment, the collection of the rules in a rule engine forms the rule base, and the term “firing” may be used to describe evaluating all the rules in the rule base over all the facts that are stored in the working memory; that is checking the condition over the facts contained in the working memory, and then executing the code of the consequence. In one embodiment, firing rules may cause new facts to be inserted into the working memory (as part of the logic contained in the consequence). This may trigger the execution of other rules; the process continues until a fixed point is reached.

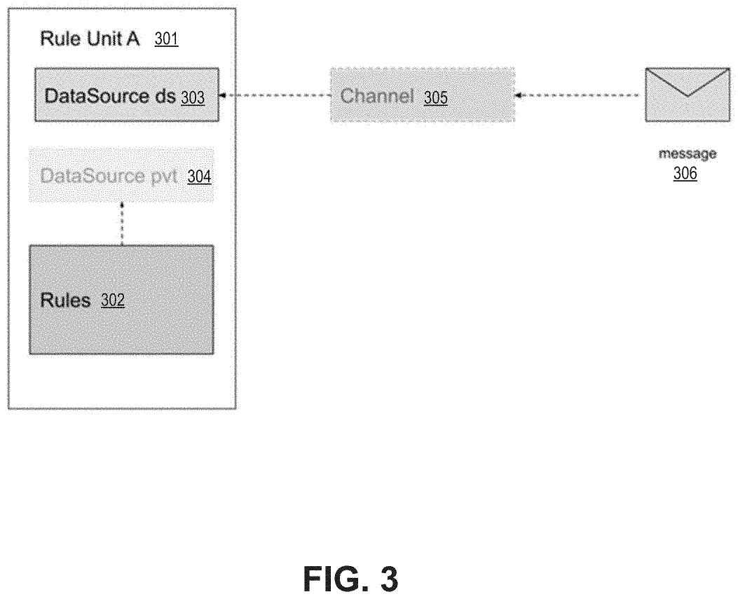

FIG. 3 is a block diagram that illustrates an example rule unit 301, in accordance with some embodiments of the present disclosure. In one embodiment, Rule Unit A 301 is a partition of the rule base 302 that contains also one or more references to partitions of the working memory. Such references to the working memory may point to shared (e.g., 303) or private (e.g., 304) areas of the working memory and may be called data sources. In one embodiment, private areas 303 can effectively be seen as a local memory of the unit 301.

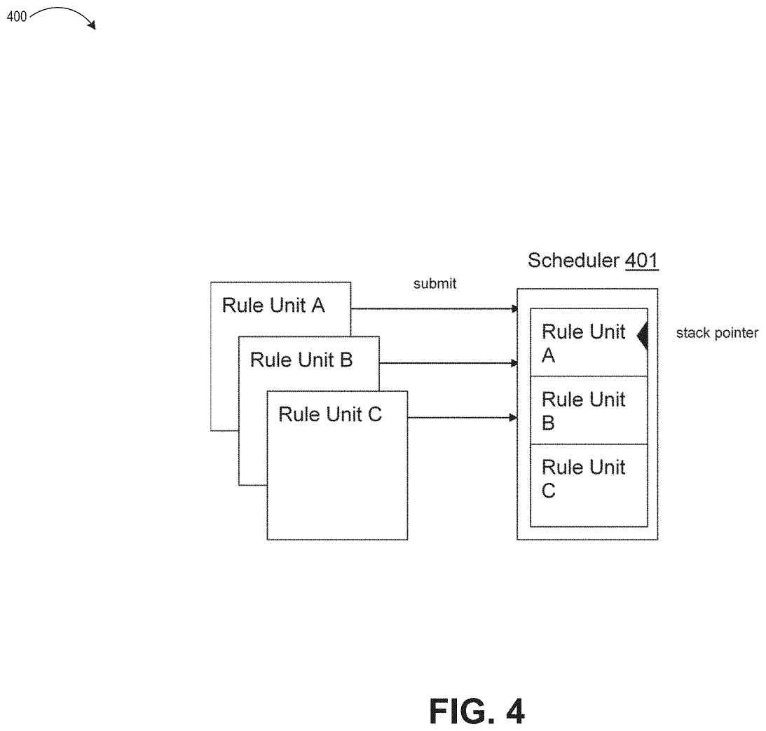

In one embodiment, a shared data source (e.g., DataSource ds 302) may be accessed externally through a channel 305, where data is actually stored. In this case, putting a message 306 onto a channel 305 may be equivalent to inserting a fact into a datasource. In one embodiment, such a channel may be referred to as a backing channel of the data source. In one embodiment, rule unit 301 may be scheduled for execution, as described with respect to FIG. 4, below.

FIG. 4 is a block diagram that illustrates an example scheduler 401, in accordance with some embodiments of the present disclosure. In one embodiment, a unit (e.g., a “unit of execution”) is a piece of knowledge (in this case, rules and data) that can be scheduled for execution. Scheduling a unit for execution means demanding the scheduler 401 the firing of its rules.

In one embodiment, a unit can be thought of as a small-scale rules engine that has visibility on only a portion of the rule base and only a portion of the working memory. Referring now to FIG. 3 and FIG. 4, when the scheduler 401 puts a unit into execution, processing logic may perform a variety of actions. For example, in one embodiment, processing logic may check all the backing channels (e.g., 605) for incoming data (e.g., 306) and put it in the local working memory (e.g., public memory 303 and/or private/local memory 304). Processing logic may then cause the unit (e.g., 301) to fire its rules 302).

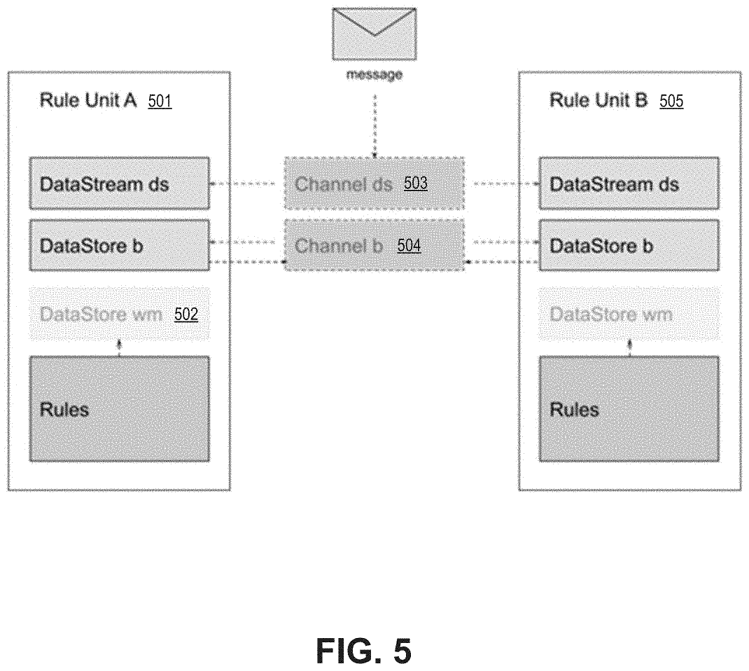

Referring to FIG. 5, processing logic may cause unit 501 to propagate changes in the local working memory 502 to the shared channels (e.g., 503 and 504). In one embodiment, message passing over shared channels 503 and 504 thus works as a mechanism to coordinate execution across rule units (e.g., 501 and 505).

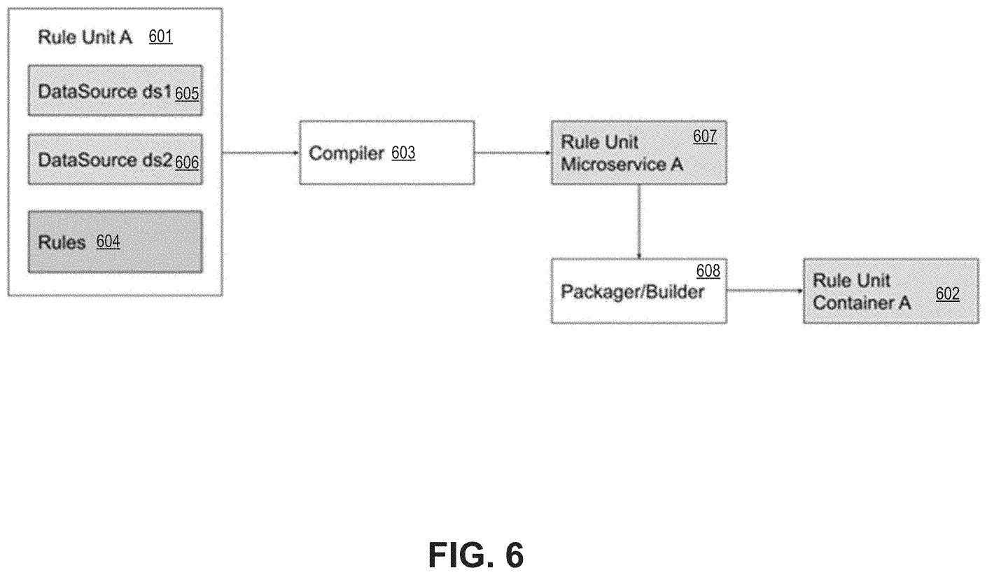

Referring now to FIG. 6, a rule unit 601 may be exposed as a containerized microservice 602 according to the following embodiments. In one embodiment, the rule unit 601 is declared through the use of a manifest file, or by any other suitable method and file type.

The rule unit compiler 603 builds the rules 604 into an executable format (e.g. Java® or native executable) that exposes read/write to DataSources (e.g., 605 and 606) via API (e.g. message bus or REST API) and code-generates a Rule Unit Microservice 607. In one embodiment, the Rule Unit Microservice 607 may be packaged 608 in a container image (e.g. via Docker) generating Rule Unit Container 602.

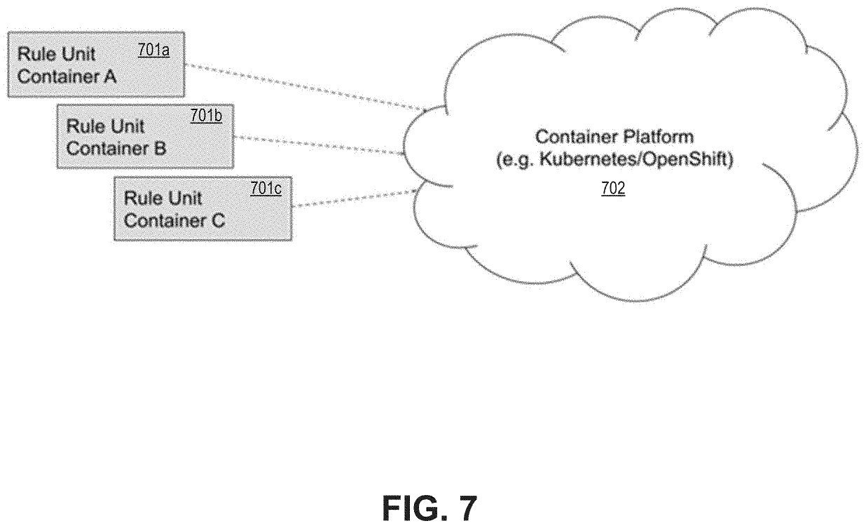

Referring to FIG. 7, each Rule Unit Container 701a, 701b, 701c may be deployed on a container platform 702. In one embodiment, the container platform 702 reads the manifest file and binds each data source to an appropriate backing channel. In one embodiment, the scheduling of a rule unit (e.g., 701a-c) may be requested/demanded of the container platform scheduler and may be, for all intents and purposes, equivalent to scheduling the containerized rule unit service in other embodiments.

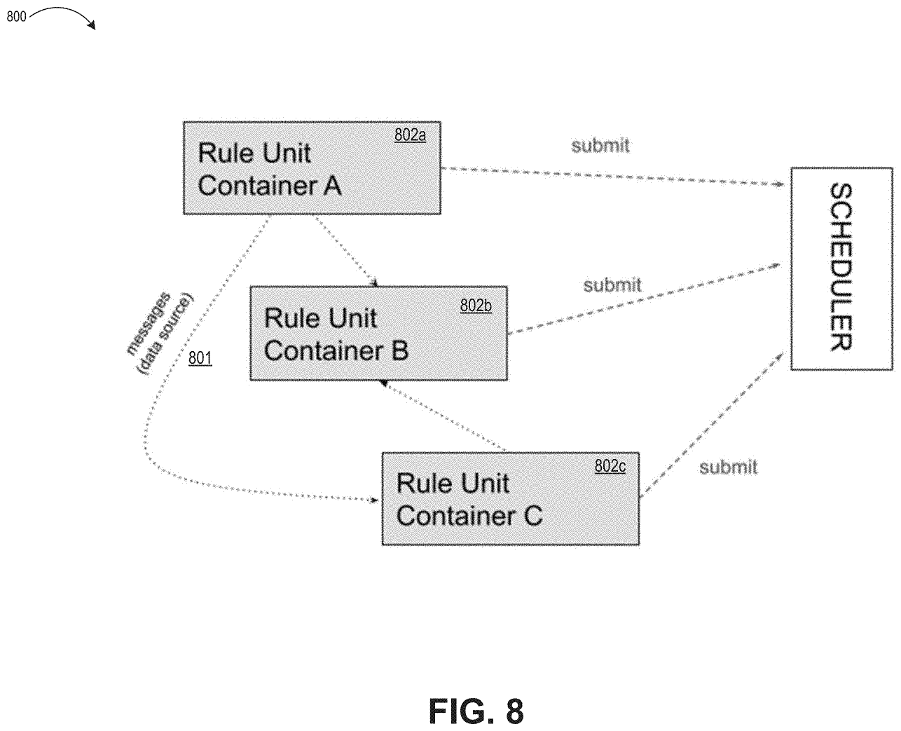

Referring to FIG. 8, engine orchestration may be provided through message passing, as described herein. In one embodiment, messages incoming from the external world (outside the cluster) may be written on the backing channels of the unit data sources. In one embodiment, messages 801 may flow through each container 802a, 802b, 802c by writing on the shared backing channels.

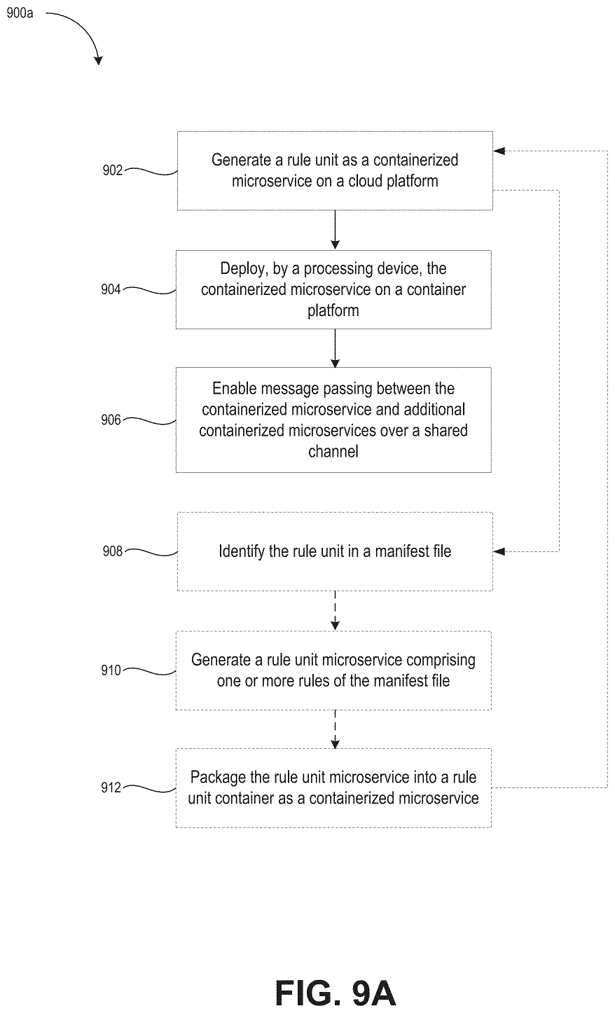

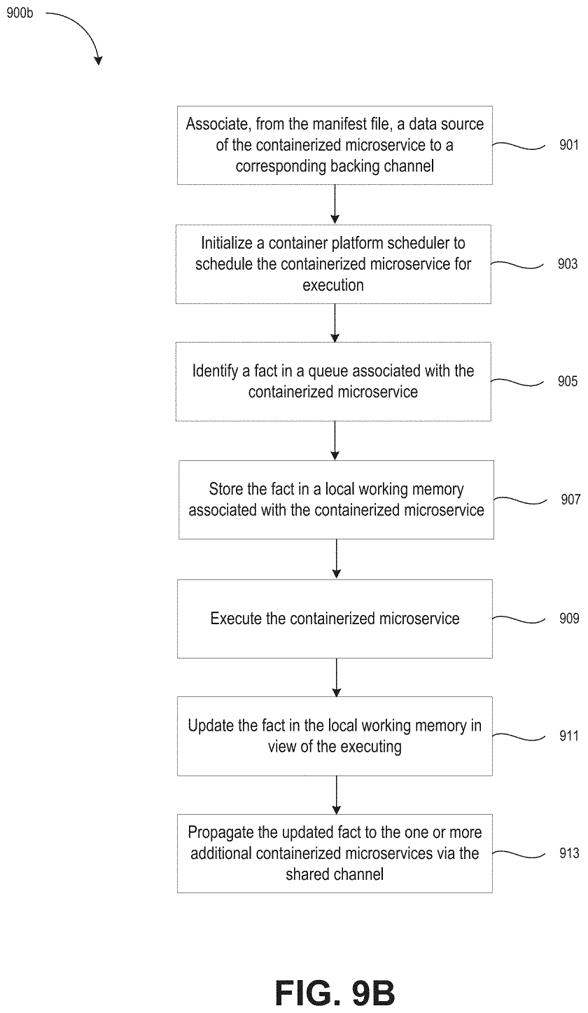

FIG. 9A is a flow diagram of a first method 900a of the containerized distributed rules engine, in accordance with some embodiments of the present disclosure. The method 900a may be performed by processing logic that comprises hardware (e.g., circuitry, dedicated logic, programmable logic, microcode, etc.), software (e.g., instructions run on a processing device to perform hardware simulation), or a combination thereof. In one embodiment, processing logic corresponding to one or more components of FIG. 1B may perform one or more of the following operations. For example, in one embodiment, processing logic of processing device 120 performs the following operations, with respect to the following components of FIG. 1B. In another embodiment, any other suitable processing device may perform the described operations.

Referring to FIG. 9A, at block 902, processing logic may generate a rule unit as a containerized microservice 151 on the cloud platform 103, deploy the containerized microservice 151 on the container platform 121 (block 904), and enable message passing between the containerized microservice 151 and additional containerized microservices 153 (all, or some of which, may be located within or outside of container platform 121) over a shared channel 107 (block 906), as described herein.

In one embodiment, to generate the rule unit as the containerized microservice 151 the processing device 120 may first identify the rule unit in the manifest file 107, and then generate a rule unit microservice including one or more rules of the manifest file. Processing device 120 may then package the rule unit microservice into a rule unit container as the containerized microservice 151, or into one or more distinct containerized microservices (e.g., 153). In on embodiment, processing device 120 may generate the one or more rules of the manifest file in an executable format. For example, the executable format may be generated in Java® or a native executable. In one embodiment, the executable format may provide read and write access to a data source corresponding to the rule via an application programming interface (API). In one embodiment, the API may the API is a representational state transfer (REST) API. In another embodiment, a message bus may be employed.

FIG. 9B is a flow diagram of a first method 900b of the containerized distributed rules engine, in accordance with some embodiments of the present disclosure. The method 900b may be performed by processing logic that comprises hardware (e.g., circuitry, dedicated logic, programmable logic, microcode, etc.), software (e.g., instructions run on a processing device to perform hardware simulation), or a combination thereof. In one embodiment, processing logic corresponding to one or more components of FIG. 1B may perform one or more of the following operations. For example, in one embodiment, processing logic of processing device 120 performs the following operations, with respect to the following components of FIG. 1B. In another embodiment, any other suitable processing device may perform the described operations.

Referring to FIG. 9B, at block 901, processing logic may, to deploy the containerized microservice 151 on the container platform 121, associate, from the manifest file 107, a data source of the containerized microservice 151 to a corresponding backing channel and initialize a container platform scheduler to schedule the containerized microservice for execution (block 903).

In one embodiment, execution of the microservice may be performed by the scheduler in a variety of contexts. For example, in one embodiment, processing device 120 may identify a fact in a queue associated with the containerized microservice (905), store the fact in the local memory associated with the containerized microservice (e.g., in local memory 130) (e.g., block 907), and execute the containerized microservice 151 (e.g., block 909). In one embodiment, processing device 120 may further update the fact in the local memory 130 in view of the executing (block 911) and propagate the updated fact to the one or more additional containerized microservices 153 via the shared channel 107 (block 913).

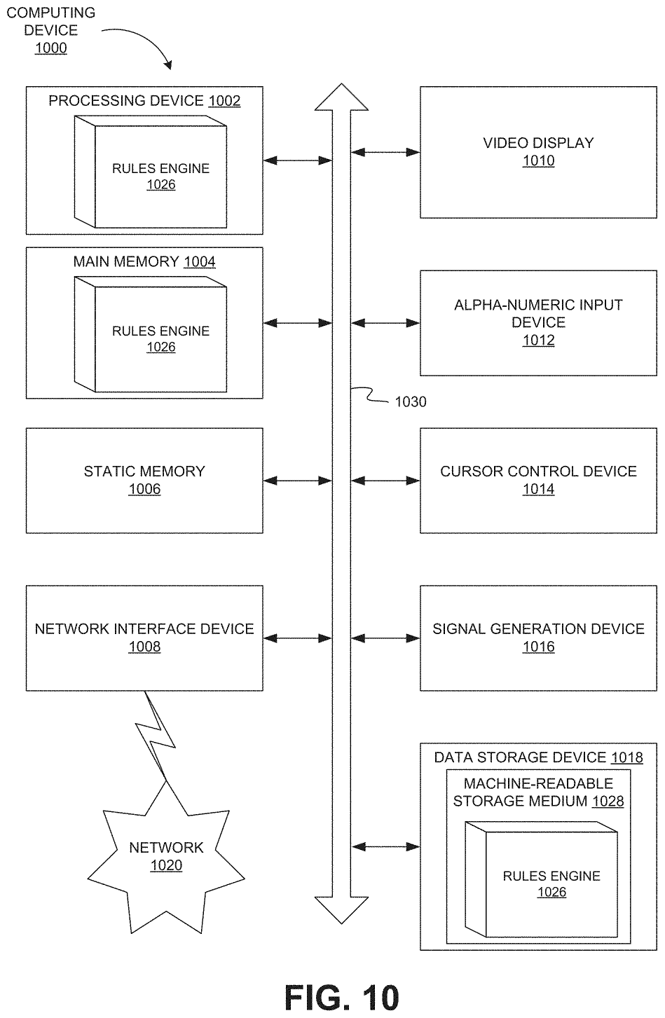

FIG. 10 is a block diagram of an example computing device 1000 that may perform one or more of the operations described herein, in accordance with some embodiments of the present disclosure. Computing device 1000 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 1000 may include a processing device (e.g., a general purpose processor, a PLD, etc.) 1002, a main memory 1004 (e.g., synchronous dynamic random access memory (DRAM), read-only memory (ROM)), a static memory 1006 (e.g., flash memory and a data storage device 1018), which may communicate with each other via a bus 1030.

Processing device 1002 may be provided by one or more general-purpose processing devices such as a microprocessor, central processing unit, or the like. In an illustrative example, processing device 1002 may comprise a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 1002 may also comprise one or more special-purpose processing devices such as an application specific integrated circuit (ASIC), a field programmable gate array (FPGA), a digital signal processor (DSP), network processor, or the like. The processing device 1002 may be configured to execute the operations described herein, in accordance with one or more aspects of the present disclosure, for performing the operations and steps discussed herein. In one embodiment, processing device 1002 represents processing device 120 of FIG. 1A. In another embodiment, processing device 1002 represents a processing device of a client device (e.g., client device 150 of FIG. 1A).

Computing device 1000 may further include a network interface device 1008 which may communicate with a network 1020. The computing device 1000 also may include a video display unit 1010 (e.g., a liquid crystal display (LCD) or a cathode ray tube (CRT)), an alphanumeric input device 1012 (e.g., a keyboard), a cursor control device 1014 (e.g., a mouse) and an acoustic signal generation device 1016 (e.g., a speaker). In one embodiment, video display unit 1010, alphanumeric input device 1012, and cursor control device 1014 may be combined into a single component or device (e.g., an LCD touch screen).

Data storage device 1018 may include a computer-readable storage medium 1028 on which may be stored one or more sets of instructions, e.g., instructions for carrying out the operations described herein, in accordance with one or more aspects of the present disclosure. Instructions implementing rules engine 1026 may also reside, completely or at least partially, within main memory 1004 and/or within processing device 1002 during execution thereof by computing device 1000, main memory 1004 and processing device 1002 also constituting computer-readable media. The instructions may further be transmitted or received over a network 1020 via network interface device 1008.

While computer-readable storage medium 1028 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

Example 1 is a method, comprising: generating a rule unit as a containerized microservice on a cloud platform; deploying, by a processing device, the containerized microservice on a container platform; and enabling message passing between the containerized microservice and additional containerized microservices over a shared channel.

Example 2 is the method of Example 1, wherein generating the rule unit as the containerized microservice comprises: identifying the rule unit in a manifest file; generating a rule unit microservice comprising one or more rules of the manifest file; and packaging the rule unit microservice into a rule unit container as a containerized microservice.

Example 3 is a method of Example 2, further comprising generating the one or more rules of the manifest file in an executable format.

Example 4 is the method of Example 3, wherein the executable format provides read and write access to a data source corresponding to the rule via an application programming interface (API).

Example 5 is the method of Example 4, wherein the API is a representational state transfer (REST) API.

Example 6 is the method of Example 2, wherein deploying the containerized microservice on the container platform comprises: associating, from the manifest file, a data source of the containerized microservice to a corresponding backing channel; and initializing a container platform scheduler to schedule the containerized microservice for execution.

Example 7 is the method of Example 6, further comprising: identifying a fact in a queue associated with the containerized microservice; storing the fact in a local working memory associated with the containerized microservice; executing the containerized microservice; updating the fact in the local working memory in view of the executing; and propagating updated fact to the one or more additional containerized microservices via the shared channel.

Example 8 is a system, comprising: a local memory; and a processing device operatively coupled to the memory, the processing device to: generate a rule unit as a containerized microservice on a cloud platform; deploy the containerized microservice on a container platform; and enable message passing between the containerized microservice and additional containerized microservices over a shared channel.

Example 9 is the system of Example 8, wherein to generate the rule unit as the containerized microservice the processing device is to: identify the rule unit in a manifest file; generate a rule unit microservice comprising one or more rules of the manifest file; and package the rule unit microservice into a rule unit container as a containerized microservice.

Example 10 is the system of Example 9, the processing device further to generate the one or more rules of the manifest file in an executable format.

Example 11 is the system of Example 10, wherein the executable format provides read and write access to a data source corresponding to the rule via an application programming interface (API).

Example 12 is the system of Example 11, wherein the API is a representational state transfer (REST) API.

Example 13 is the system of Example 9, wherein to deploy the containerized microservice on the container platform the processing device is to: associate, from the manifest file, a data source of the containerized microservice to a corresponding backing channel; and initialize a container platform scheduler to schedule the containerized microservice for execution.

Example 14 is the system of Example 13, the processing device further to: identify a fact in a queue associated with the containerized microservice; store the fact in the local memory associated with the containerized microservice; execute the containerized microservice; update the fact in the local memory in view of the executing; and propagate the updated fact to the one or more additional containerized microservices via the shared channel.

Example 15 is a non-transitory computer-readable storage medium including instructions that, when executed by a processing device, cause the processing device to: generate a rule unit as a containerized microservice on a cloud platform; deploy the containerized microservice on a container platform; and enable, by the processing device, message passing between the containerized microservice and additional containerized microservices over a shared channel.

Example 16 is the non-transitory computer-readable storage medium of Example 15, wherein to generate the rule unit as the containerized microservice the processing device is to: identify the rule unit in a manifest file; generate a rule unit microservice comprising one or more rules of the manifest file; and package the rule unit microservice into a rule unit container as a containerized microservice.

Example 17 is the non-transitory computer-readable storage medium of claim 16, the processing device further to generate the one or more rules of the manifest file in an executable format.

Example 18 is the non-transitory computer-readable storage medium of Example 17, wherein the executable format provides read and write access to a data source corresponding to the rule via an application programming interface (API).

Example 19 is the system of Example 18, wherein the API is a representational state transfer (REST) API.

Example 20 is the non-transitory computer-readable storage medium of Example 16, wherein to deploy the containerized microservice on the container platform the processing device is to: associate, from the manifest file, a data source of the containerized microservice to a corresponding backing channel; and initialize a container platform scheduler to schedule the containerized microservice for execution.

Example 21 is the non-transitory computer-readable storage medium of Example 20, the processing device further to: identify a fact in a queue associated with the containerized microservice; store the fact in a local memory associated with the containerized microservice; execute the containerized microservice; update the fact in the local memory in view of the executing; and propagate the updated fact to the one or more additional containerized microservices via the shared channel.

Example 22 is an apparatus, comprising: means for generating a rule unit as a containerized microservice on a cloud platform; means for deploying, by a processing device, the containerized microservice on a container platform; and means for enabling message passing between the containerized microservice and additional containerized microservices over a shared channel.

Example 23 is the apparatus of Example 22, wherein generating the rule unit as the containerized microservice comprises: means for identifying the rule unit in a manifest file; means for generating a rule unit microservice comprising one or more rules of the manifest file; and means for packaging the rule unit microservice into a rule unit container as a containerized microservice.

Example 24 is the apparatus of Example 23, further comprising means for generating the one or more rules of the manifest file in an executable format.

Example 25 is the apparatus of Example 24, wherein the executable format provides read and write access to a data source corresponding to the rule via an application programming interface (API).

Example 26 is the apparatus of Example 25, wherein the API is a representational state transfer (REST) API.

Example 27 is the apparatus of Example 23, wherein deploying the containerized microservice on the container platform comprises: means for associating, from the manifest file, a data source of the containerized microservice to a corresponding backing channel; and means for initializing a container platform scheduler to schedule the containerized microservice for execution.

Example 28 is the apparatus of Example 27, further comprising: means for identifying a fact in a queue associated with the containerized microservice; means for storing the fact in a local working memory associated with the containerized microservice; means for executing the containerized microservice; means for updating the fact in the local working memory in view of the executing; and means for propagating updated fact to the one or more additional containerized microservices via the shared channel.

Example 29 is a cloud platform, comprising: a local memory; a containerized microservice; a container platform; a shared channel; and a processing device operatively coupled to: the memory, the containerized microservice, the container platform, and the shared channel, the processing device to: generate a rule unit as the containerized microservice on the cloud platform; deploy the containerized microservice on the container platform; and enable message passing between the containerized microservice and additional containerized microservices over the shared channel.

Example 30 is the cloud platform of Example 29, wherein to generate the rule unit as the containerized microservice the processing device is to: identify the rule unit in a manifest file; generate a rule unit microservice comprising one or more rules of the manifest file; and package the rule unit microservice into a rule unit container as a containerized microservice.

Example 31 is the cloud platform of Example 30, the processing device further to generate the one or more rules of the manifest file in an executable format.

Example 32 is the cloud platform of Example 31, wherein the executable format provides read and write access to a data source corresponding to the rule via an application programming interface (API).

Example 33 is the cloud platform of Example 32, wherein the API is a representational state transfer (REST) API.

Example 34 is the cloud platform of Example 30, wherein to deploy the containerized microservice on the container platform the processing device is to: associate, from the manifest file, a data source of the containerized microservice to a corresponding backing channel; and initialize a container platform scheduler to schedule the containerized microservice for execution.

Example 35 is the cloud platform of Example 34, the processing device further to: identify a fact in a queue associated with the containerized microservice; store the fact in the local memory associated with the containerized microservice; execute the containerized microservice; update the fact in the local memory in view of the executing; and propagate the updated fact to the one or more additional containerized microservices via the shared channel.

Unless specifically stated otherwise, terms such as “receiving,” “routing,” “updating,” “providing,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method, comprising:
generating a rule unit as a containerized microservice on a cloud platform;
deploying, by a processing device, the containerized microservice on a container platform; and
enabling message passing between the containerized microservice and additional containerized microservices over a shared channel.

2. The method of claim 1, wherein generating the rule unit as the containerized microservice comprises:
identifying the rule unit in a manifest file;
generating a rule unit microservice comprising one or more rules of the manifest file; and
packaging the rule unit microservice into a rule unit container as a containerized microservice.

3. The method of claim 2, further comprising generating the one or more rules of the manifest file in an executable format.

4. The method of claim 3, wherein the executable format provides read and write access to a data source corresponding to the rule via an application programming interface (API).

5. The method of claim 4, wherein the API is a representational state transfer (REST) API.

6. The method of claim 2, wherein deploying the containerized microservice on the container platform comprises:
associating, from the manifest file, a data source of the containerized microservice to a corresponding backing channel; and
initializing a container platform scheduler to schedule the containerized microservice for execution.

7. The method of claim 6, further comprising:
identifying a fact in a queue associated with the containerized microservice;
storing the fact in a local working memory associated with the containerized microservice;
executing the containerized microservice;
updating the fact in the local working memory in view of the executing; and
propagating updated fact to the one or more additional containerized microservices via the shared channel.

8. A system, comprising:
a local memory; and
a processing device operatively coupled to the memory, the processing device to:
generate a rule unit as a containerized microservice on a cloud platform;
deploy the containerized microservice on a container platform; and
enable message passing between the containerized microservice and additional containerized microservices over a shared channel.

9. The system of claim 8, wherein to generate the rule unit as the containerized microservice the processing device is to:
identify the rule unit in a manifest file;
generate a rule unit microservice comprising one or more rules of the manifest file; and
package the rule unit microservice into a rule unit container as a containerized microservice.

10. The system of claim 9, the processing device further to generate the one or more rules of the manifest file in an executable format.

11. The system of claim 10, wherein the executable format provides read and write access to a data source corresponding to the rule via an application programming interface (API).

12. The system of claim 11, wherein the API is a representational state transfer (REST) API.

13. The system of claim 9, wherein to deploy the containerized microservice on the container platform the processing device is to:
associate, from the manifest file, a data source of the containerized microservice to a corresponding backing channel; and
initialize a container platform scheduler to schedule the containerized microservice for execution.

14. The system of claim 13, the processing device further to:
identify a fact in a queue associated with the containerized microservice;
store the fact in the local memory associated with the containerized microservice;
execute the containerized microservice;
update the fact in the local memory in view of the executing; and
propagate the updated fact to the one or more additional containerized microservices via the shared channel.

15. A non-transitory computer-readable storage medium including instructions that, when executed by a processing device, cause the processing device to:
generate a rule unit as a containerized microservice on a cloud platform;
deploy the containerized microservice on a container platform; and
enable, by the processing device, message passing between the containerized microservice and additional containerized microservices over a shared channel.

16. The non-transitory computer-readable storage medium of claim 15, wherein to generate the rule unit as the containerized microservice the processing device is to:
identify the rule unit in a manifest file;
generate a rule unit microservice comprising one or more rules of the manifest file; and
package the rule unit microservice into a rule unit container as a containerized microservice.

17. The non-transitory computer-readable storage medium of claim 16, the processing device further to generate the one or more rules of the manifest file in an executable format.

18. The non-transitory computer-readable storage medium of claim 17, wherein the executable format provides read and write access to a data source corresponding to the rule via an application programming interface (API).

19. The non-transitory computer-readable storage medium of claim 16, wherein to deploy the containerized microservice on the container platform the processing device is to:
associate, from the manifest file, a data source of the containerized microservice to a corresponding backing channel; and
initialize a container platform scheduler to schedule the containerized microservice for execution.

20. The non-transitory computer-readable storage medium of claim 19, the processing device further to:
identify a fact in a queue associated with the containerized microservice;
store the fact in a local memory associated with the containerized microservice;
execute the containerized microservice;
update the fact in the local memory in view of the executing; and
propagate the updated fact to the one or more additional containerized microservices via the shared channel.
